(19) United States
(12) Patent Application Publication
(10) Pub. No.: US 2022/0237445 A1
(43) Pub. Date: Jul. 28, 2022

(54) SYSTEMS AND METHODS FOR ANOMALY DETECTION

(71) Applicant: Walmart Apollo, LLC, Bentonville, AR (US)

(72) Inventors: Tzu-Yen Wang, San Mateo, CA (US); Jingru Zhou, San Jose, CA (US); Hui-Min Chen, Pleasanton, CA (US); Zhiping Tang, Cupertino, CA (US)

(21) Appl. No.: 17/160,207

(22) Filed: Jan. 27, 2021

(51) Int. Cl. G06N 3/08; G06K 9/62; G06N 3/04; G06F 40/289

(52) U.S. Cl. CPC G06N 3/08; G06K 9/6215; G06F 40/289; G06N 3/0445; G06K 9/6232

(57) ABSTRACT

Systems and methods for identifying anomalous interactions are disclosed. Interaction data representative of an interaction is received and the interaction is classified as one of an anomalous interaction or a benign interaction using an anomaly detection model. The anomaly detection model is configured to identify a similarity between the interaction data and known benign interactions. An indication of authorization is generated based on the classification of the interaction. The indication of authorization authorizes the interaction when the anomaly detection model classifies the interaction as benign and the indication of authorization denies the interaction when the anomaly detection model classifies the interaction as anomalous.

### TECHNICAL FIELD

This application relates generally to anomaly detection and, more particularly, anomaly detection using deep learning processes.

### BACKGROUND

Identification of anomalous interactions in various systems or networks is necessary to reduce fraud, protect users of the system, or otherwise control interactions with the system. The detection of anomalous interactions is complicated by the low volume of such interactions and by the changing tactics used by bad actors.

For example, in a retail environment, the tactics employed to perform a fraudulent return may change rapidly over time to prevent detection. Manual detection of fraudulent returns is difficult due to the low volume of such transactions, the lack of confirmation for fraudulent transactions, and the unsupervised nature of the interactions.

### SUMMARY

In various embodiments, a system is disclosed. The system includes a non-transitory memory having instructions stored thereon and a processor configured to read the instructions. The processor is configured to receive interaction data representative of an interaction, classify the interaction as one of an anomalous interaction or a benign interaction using an anomaly detection model, and generate an indication of authorization based on the classification of the interaction. The anomaly detection model is configured to identify a similarity between the interaction data and known benign interactions. The indication of authorization authorizes the interaction when the anomaly detection model classifies the interaction as benign and denies the interaction when the anomaly detection model classifies the interaction as anomalous.

In various embodiments, a non-transitory computer readable medium having instructions stored thereon is disclosed. The instructions, when executed by a processor cause a device to perform operations including receiving interaction data representative of an interaction, classifying the interaction as one of an anomalous interaction or a benign interaction using an anomaly detection model, and generating an indication of authorization based on the classification of the interaction. The anomaly detection model is configured to identify a similarity between the interaction data and known benign interactions. The indication of authorization authorizes the interaction when the anomaly detection model classifies the interaction as benign and denies the interaction when the anomaly detection model classifies the interaction as anomalous.

In various embodiments, a computer-implemented method is disclosed. The computer-implemented method includes the steps of receiving interaction data representative of an interaction, classifying the interaction as one of an anomalous interaction or a benign interaction using an anomaly detection model, and generating an indication of authorization based on the classification of the interaction. The anomaly detection model is configured to identify a similarity between the interaction data and known benign interactions. The indication of authorization authorizes the interaction when the anomaly detection model classifies the interaction as benign and denies the interaction when the anomaly detection model classifies the interaction as anomalous.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a block diagram of a computer system, in accordance with some embodiments.

FIG. 2 illustrates a network environment configured to perform anomaly detection, in accordance with some embodiments.

FIG. 3 is a flowchart illustrating a method of identifying an anomalous interaction, in accordance with some embodiments.

FIG. 4 illustrates a process flow illustrating various steps of the method illustrated in FIG. 3, in accordance with some embodiments.

FIG. 5 illustrates an anomaly detection model, in accordance with some embodiments.

FIG. 6 is a flowchart illustrating a method of training an anomaly detection model, in accordance with some embodiments.

FIG. 7 is a process flow illustrating various steps of the method illustrated in FIG. 6, in accordance with some embodiments.

FIG. 8 illustrates a training data set that includes a first set of historical events associated with a first user, a second set of historical events associated with a second user, and a third set of historical events associated with a third user, in accordance with some embodiments.

FIG. 9A illustrates a training subset generated by selecting subsets of events associated with only a first customer, in accordance with some embodiments.

FIG. 9B illustrates a training subset generated by randomly selecting subsets of events associated with a first customer, a second customer, and a third customer, in accordance with some embodiments.

FIG. 10 illustrates a machine learning model including a recurrent neural network (RNN), in accordance with some embodiments.

FIG. 11 illustrates a machine learning model including a plurality of long short term memory (LSTM) cells, in accordance with some embodiments.

FIG. 12 illustrates an embodiment of a self-supervised model with encoder-decoder architecture including a plurality of LSTM cells, in accordance with some embodiments.

FIG. 13A illustrates one embodiment of a store prediction model during training, in accordance with some embodiments.

FIG. 13B illustrates a store vector conversion model, in accordance with some embodiments.

FIG. 14A illustrates one embodiment of an item classification model, in accordance with some embodiments.

FIG. 14B illustrates an item vector conversion model, in accordance with some embodiments.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. In the claims, means-plus-function clauses, if used, are intended to cover structures described, suggested, or rendered obvious by the written description or drawings for performing the recited function, including not only structure equivalents but also equivalent structures.

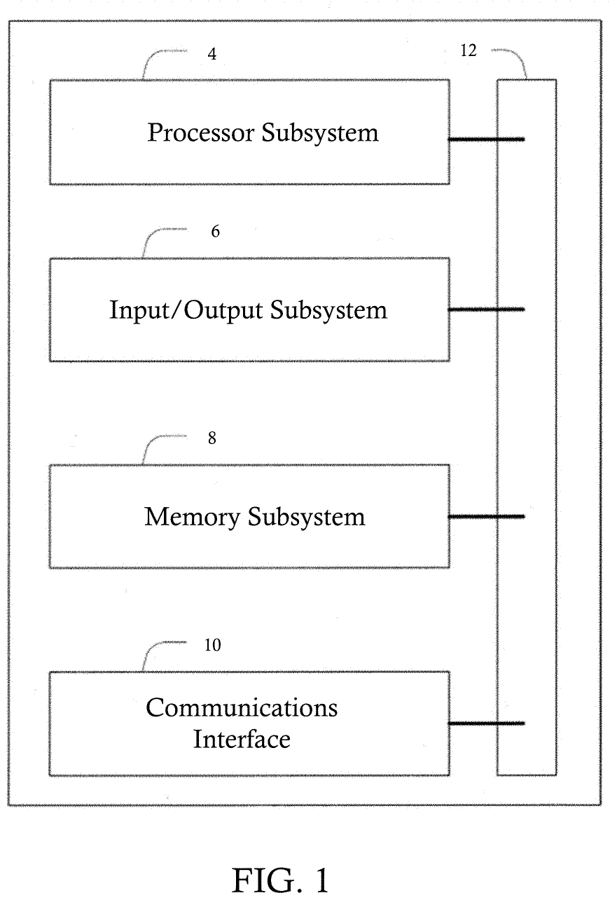

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 6. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 4.

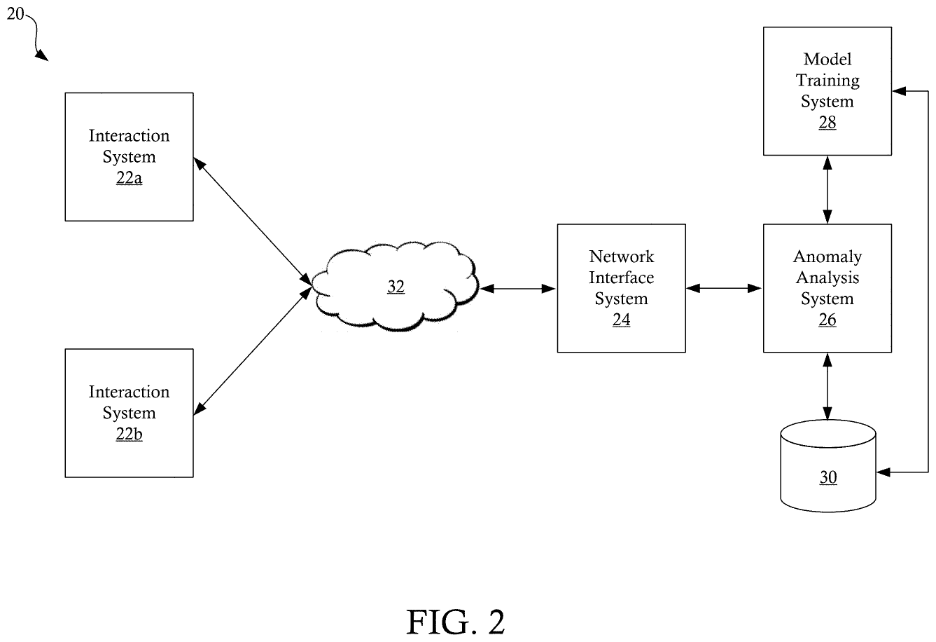

FIG. 2 illustrates a network environment 20 configured to perform anomaly detection, in accordance with some embodiments. The network environment 20 may include, but is not limited to, one or more interaction systems 22a-22b, at least one network interface system 24, at least one anomaly analysis system 26, at least one model training system 28, and/or at least one database 30. Each of the interaction systems 22a-22b, network interface system 24, anomaly analysis system 26, and/or model training system 28 may include a system as described above with respect to FIG. 1. Although embodiments are illustrates herein having discrete systems, it will be appreciated that one or more of the illustrated systems may be combined into a single system configured to implement the functionality and/or services of each of the combined systems. For example, although embodiments are illustrated and discussed herein including each of a network interface system 24, anomaly analysis system 26, and a model training system 28, it will be appreciated that these systems may be combined into a single logical and/or physical system configured to perform the functions and/or provide services associated with each of the individual systems. It will also be appreciated that each of the illustrated systems may be replicated and/or split into multiple systems configured to perform similar functions and/or parts of a function.

In some embodiments, each of the plurality of interaction systems 22a-22b is configured to provide one or more interactions that are evaluated by the anomaly analysis system 26. For example, in some embodiments, the interaction systems 22a-22b are configured to provide retail interactions such as sales, returns, and/or other interactions in a retail environment. Although embodiments are discussed herein including interaction systems 22a-22b operating in a retail environment, it will be appreciated that the interaction systems can be configured to provide any suitable interaction for evaluation by the anomaly analysis system 26.

In some embodiments, each of the interaction systems 22a-22b are configured to provide data to the network interface system 24. For example, in some embodiments, the interaction systems 22a-22b include systems configured to generate records of customer interactions with one or more retail avenues, such as, for example, brick-and-mortar purchases, online purchases, and/or otherwise providing customer records or purchase records including attributes of various products or services. In some embodiments, the records of customer interactions include sales data, return data, and/or any other suitable interaction data.

In some embodiments, the anomaly analysis system 26 is configured to implement one or more processes for identifying anomalies in the interaction data. The anomaly analysis system 26 may be configured to detect anomalies in interactions lacking final feedback, for example, a final indication as provided by a credit card or other payment authorization. For example, in various embodiments, the anomaly analysis system 26 is configured to detect one or more suspicious or fraudulent returns included in the interaction data. The interaction data may include records associated with each of the customer systems 22a-22b and/or records for customers associated with other systems or interactions. In some embodiments, customer records may be stored in a database, such as database 30. In the context of an e-commerce environment, each of the customer records may include purchase histories including attributes associated with the customer and/or with each of the purchased products. For example, customer records may include attributes such as color, brand, size, category, etc.

As discussed in greater detail below, the anomaly analysis system 26 may be configured to implement one or more trained anomaly detection models configured to detect anomalies, such as, for example, one or more suspicious or fraudulent returns. In some embodiments, the anomaly analysis system 26 is configured to identify series of returns that are suspicious and/or fraudulent. The one or more anomaly detection models may be configured to identify anomalies by identifying interactions, such as transactions, that are non-conforming with respect to benign (e.g., legitimate) interactions. For example, an anomaly analysis system 26 configured to detect suspicious or fraudulent returns may include one or more anomaly detection models configured to determine a difference (or deviation) between one or more target transactions and known, benign transactions. Transactions that are legitimate will have a small deviation from the known benign transactions, while fraudulent transactions will have greater and/or specific deviations from the known benign transactions. The anomaly analysis system 26 may be configured to flag or otherwise identify target transactions that fall outside an acceptable conformity rate as fraudulent. In some embodiments, the anomaly analysis system 26 is configured to implement a trained anomaly detection model trained using a set of known benign transactions, as discussed in greater detail below.

In some embodiments, the trained anomaly detection model is generated by the model training system 28. The model training system 28 may be configured to receive training data from a database 30, the network interface system 24, the anomaly analysis system 26, and/or any other suitable source. As discussed in greater detail below, an anomaly detection model may be trained using an iterative machine-learning process configured to train an untrained model. The anomaly detection model may be generated using historical data, real-time data, and/or any other suitable data, as discussed below. In some embodiments, the model training system 28 is configured to receive and/or store a copy of the anomaly detection model currently implemented by the anomaly analysis system 26, modify the model based on additional training data, and generate one or more additional models for implementation by the anomaly analysis system 26.

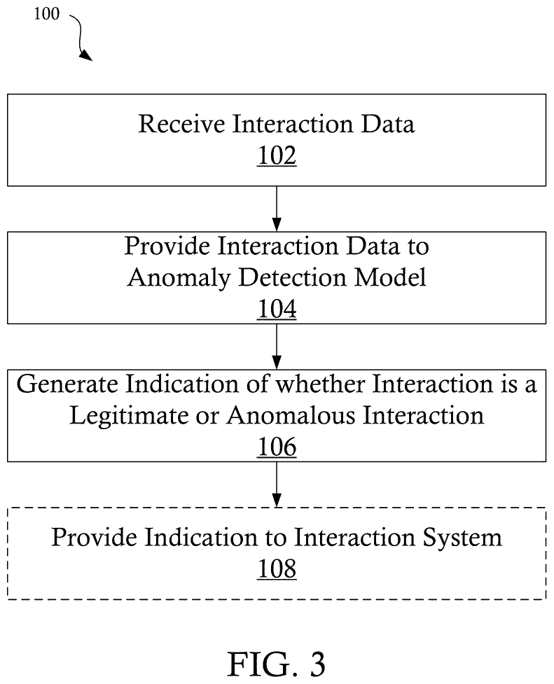

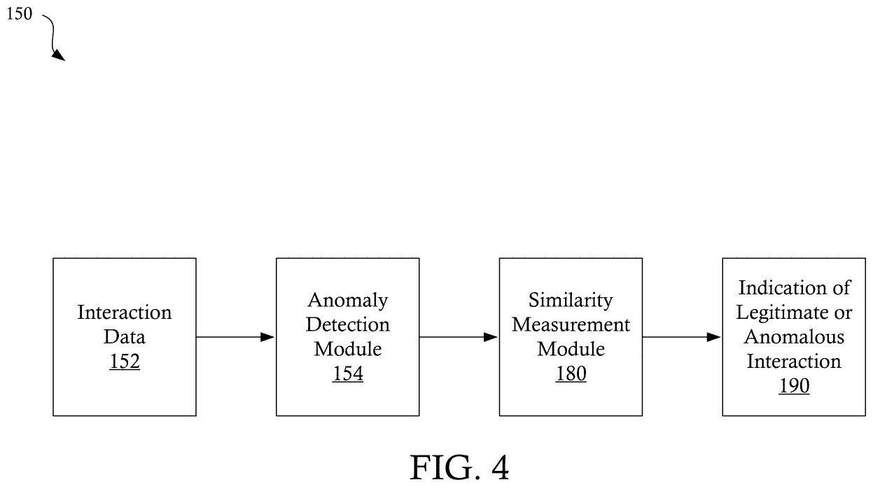

FIG. 3 is a flowchart 100 illustrating a method of identifying an anomalous interaction, in accordance with some embodiments. FIG. 4 illustrates a process flow 150 illustrating various steps of the method illustrated in FIG. 3, in accordance with some embodiments. As used herein, the term anomalous interaction includes any behavior or interaction that deviates from known benevolent interactions. For example, in various embodiments, an anomaly detection model may be configured to identify one or more of a suspicious, fraudulent, unauthorized, deviant and/or otherwise anomalous transaction.

At step 102, interaction data 152 representative of an interaction is received from an interaction system, such as, for example, one of interaction systems 22a-22b. The interaction data 152 may include data representative of any suitable interaction or event. For example, embodiments are discussed herein including a return transaction, although it will be appreciated that the disclosed systems and methods may apply to any suitable type of interaction, including retail-based interactions (e.g., purchase interactions, return interactions, service interactions, etc.), system-based interactions (e.g., system access, site access, updates, integrations, changes, etc.), and/or any other suitable interactions.

The interaction data 152 may include one or more variables, including, but not limited to: temporal data indicating a time of the return interaction; location data indicating the place of interaction; item information such as an item amount, an item quantity, a universal product code (UPC), item department, item category, item subcategory, etc.; return information including return value, return quantity, receipt return amount, non-receipt return amount, store, timestamp, validity of the interaction, etc.; and/or any other suitable interaction data. It will be understood that the interaction data 152 may include any suitable set of parameters related to and/or representative of the particular interaction type being analyzed.

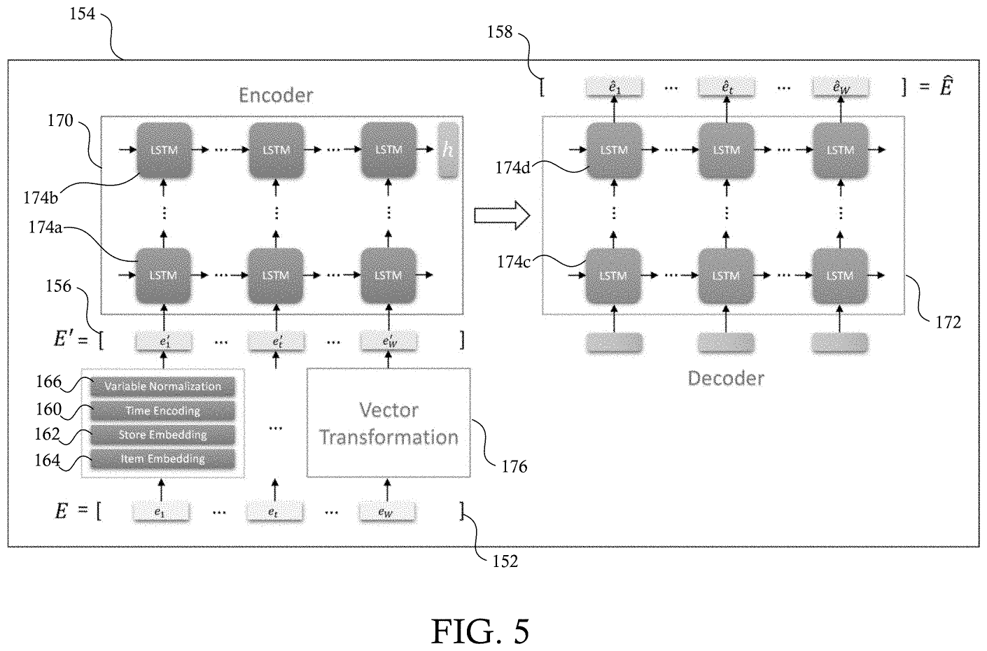

At step 104, the interaction data 152 (e.g., a 2-D tensor E) is provided to an anomaly detection model 154. The anomaly detection model 154 includes a machine learning, or artificial intelligence, model trained using a data set, as discussed in greater detail below. The anomaly detection model 154 is configured to identify anomalous interactions. In some embodiments, the anomaly detection model 154 is configured to determine a deviation between the interaction represented in the interaction data 152 and previously identified benevolent (e.g., legitimate, non-fraudulent, etc.) transactions. For example, as illustrated in FIG. 5, in some embodiments, the anomaly detection model 154 is configured to identify a deviation between an input tensor 156 (such as a 2-D tensor as discussed in greater detail below) representative of the interaction data 152 and a predicted output tensor 158 (such as a 2-D tensor as discussed in greater detail below) generated by the anomaly detection model 154. If the deviation between the input tensor 156 and the predicted output tensor 158 is equal to and/or exceeds a deviation threshold, the interaction represented by the interaction data 152 is considered suspicious and/or fraudulent. Alternatively, if the deviation is less than and/or equal to the deviation threshold, the interaction represented by the interaction data 152 is considered legitimate. It will be appreciated that the deviation threshold and/or the deviation value between the input tensor 156 and the predicted output tensor 158 may be represented using any suitable representation. It will further be appreciated that, although specific embodiments are discussed herein, any suitable machine representation of the interaction may be generated and compared by the anomaly detection model 154, and is within the scope of this disclosure.

In some embodiments, the anomaly detection model 154 is configured to convert the interaction data 152 into an input tensor 156. The interaction data 152 may include vector data and/or non-vector data. Examples of non-vector data include, but are not limited to, a transaction time, a store identifier, item identifiers, and/or other non-vector data. The anomaly detection model 154 may be configured to convert non-vector data into one or more vector representations. For example, the anomaly detection model 154 may be configured to convert transaction time into a one-hot encoding vector, item descriptions provided as text input into an item embedding 162, location (or store) information into a store embedding vector 164, and/or convert any other non-vector information into a vector encoding. Although specific embodiments are discussed herein, it will be appreciated that any suitable embedding and/or vector conversion can be performed on any of the data representative of the interaction 152.

In some embodiments, the anomaly detection model 154 is configured to perform one or more normalization processes 166 to normalize numerical data included in the interaction data 152. Currency amounts, quantities, weights, sizes, and/or any other numerical variables may be normalized by a normalization process 166. In some embodiments, normalization may be performed by the equation:

$${x}_{j}^{′} = \frac{{x}_{j} - {μ}_{j}}{{σ}_{j}} , where$$

$${μ}_{j} = {\sum }_{i = 1}^{M} {x}_{i , j} and {σ}_{j}^{2} = {\sum }_{i = 1}^{M} {( {x}_{i , j} - {μ}_{j} )}^{2}$$

and wherein xⱼ is the j^{th} numerical variable in vectorized interaction data drawn from a dataset of size M.

As discussed in greater detail below, in some embodiments, the anomaly detection model 154 is configured to generate a predicted output tensor 158 based on an encoder block 170 and a decoder block 172. In various embodiments, the encoder block 170 and/or the decoder block 172 are configured to iteratively identify shared elements of sequential data and capture temporal relationships among various event variables. For example, and as discussed in greater detail below, in some embodiments, the encoder block 170 and/or the decoder block 172 each include a recurrent neural network (RNN) having a plurality of long short-term memory (LSTM) cells 174a-174d. Although embodiments are discussed herein including an RNN network and LSTM cells, it will be appreciated that any suitable machine learning model may be applied.

In some embodiments, the anomaly detection model 154 is configured to compare the input tensor 156 to the predicted output tensor 158 using, for example, a similarity measurement. The similarity measurement may be configured to determine the deviation between the input tensor 156 and the output tensor 158. For example, in some embodiments, a similarity measurement module 180 determines a similarity according to:

$$diff ( {E}^{′} , E ) \frac{1}{W} {\sum }_{t = 1}^{W} ( {e}_{t}^{′} , {e}_{t} )$$

where e′ₜ is vectorized input data 180 of the input tensor 156 having an index t, êₜ is a corresponding output vector 182 in the output tensor 158, W is a total number of vectors in the tensors 156, 158, and L is a loss function such as a mean square error (MSE) loss function, mean absolute error (MAE) loss function, and/or any other suitable loss function.

In some embodiments, the similarity measurement is compared to a similarity threshold to determine whether the interaction 176 is anomalous or benign. For example, in some embodiments, when the deviation between the input tensor 156 and the output tensor 158 is greater than or equal to a deviation threshold, the interaction represented by the interaction data 152 does not conform to known benign transactions (or a sequence of known benign transactions) and is labeled as anomalous. When the similarity measurement is less than or equal to a deviation threshold, the interaction represented by the interaction data 152 conforms to known benign transactions (or a sequence of known benign transactions) and is labeled conforming (e.g., legitimate). It will be appreciated that the labeling of anomalous events can occur when a similarity measurement exceeds a similarity threshold when a lower similarity measurement indicates a greater similarity between events or can occur when a similarity measurement is below a similarity threshold when a higher similarity measurement indicates a greater similarity between events.

At step 106, an indication 190 indicating whether the interaction represented by the interaction data 152 is a legitimate or anomalous interaction is output from the anomaly detection model 154. The indication 190 may be used by one or more additional systems, such as, for example, an interaction system 22a-22b, to perform one or more additional processes. For example, in some embodiments, the indication is provided to an interaction system 22a-22b which authorizes a transaction, if the transaction is considered legitimate, or denies a transaction, if the transaction is considered anomalous (e.g., fraudulent, suspicious, etc.). Although embodiments are discussed herein with respect to interaction systems approving or denying a transaction, such as a return transaction, it will be appreciated that any suitable process may be applied based on the indication 190.

At optional step 108, the indication 190 is provided to a system that generated the interaction data 152, such as, for example, an interaction system 22a-22b that generated the interaction data 152. The indication 190 may be used to authorize an interaction, for example, authorize a return interaction at a retail location, online location, etc. In other embodiments, the indication 190 may be stored in a database, such as database 30, for further analysis, training, and/or other uses.

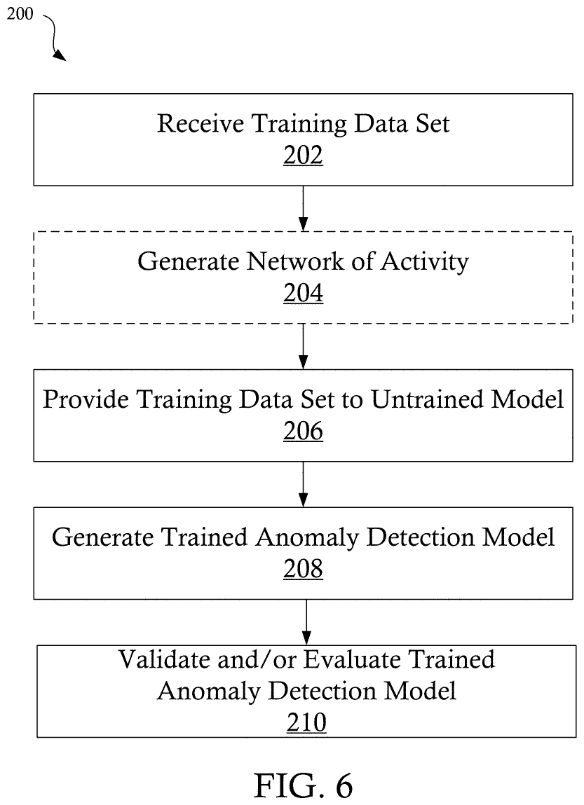

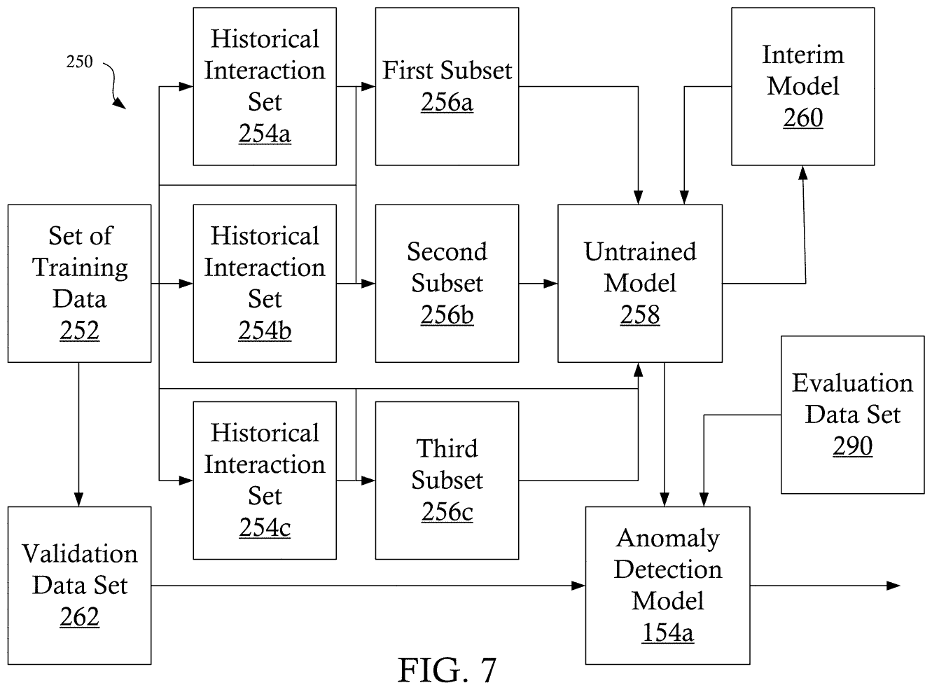

FIG. 6 is a flowchart 200 illustrating a method of training an anomaly detection model, in accordance with some embodiments. FIG. 7 is a process flow 250 illustrating various steps of the method illustrated in FIG. 6, in accordance with some embodiments. At step 202, a training data set 252 is received by a system configured to train an untrained model, such as, for example, the anomaly analysis system 26 and/or a training system 28. In some embodiments, the training data set 252 includes a set of historical interaction activity including known legitimate transactions. For example, in embodiments including return interactions, the set of historical interaction activity includes historical, legitimate return activity of one or more customers interacting at one or more locations. The one or more locations may include, for example, a physical retail location, an online retail system, and/or any other suitable location. In some embodiments, the training data set 252 may further include historical interaction activity including known anomalous and/or fraudulent interaction activity, such as, for example, one or more fraudulent return transactions associated with one or more customers.

In some embodiments, the training data set 252 may include interactions that are not associated with a single individual. At optional step 204, a network to link activity within the training data set 252 is generated. One or more users may be defined within the network based on sets of historical interactions 254a-254c. Sets of historical interactions 254a-254c may be defined over a time period. For example, in some embodiments, each of the interactions in the set of historical interactions 254a-254c includes a time stamp parameter indicating a time, date, and/or other temporal value associated with the interaction. The set of historical interactions 254a-254c may be arranged based on the associated temporal values and extend over a time period defined from the earliest-in-time temporal value and the latest-in-time temporal value. Although embodiments are discussed herein including sets of historical interactions 254a-254c, it will be appreciated that historical interactions may not include temporal values and therefore may be arranged based on one or more other parameters defined for each of the events in the training data set 252.

In some embodiments, each of the events in the training data set 252 includes a set of event variables. For example, in embodiments including historical return interaction data, the event variables may include, but is not limited to: temporal data indicating a time of the return interaction; location data indicating the place of interaction; item information such as an item amount, an item quantity, a universal product code (UPC), item department, item category, item subcategory, etc.; return information including return value, return quantity, receipt return amount, non-receipt return amount, store, timestamp, validity of the interaction, etc.; and/or any other suitable event data. In some embodiments, each event in the training data set 252 is defined as an event, e:

$${e}_{i} = [ {x}_{1} , {x}_{2} , … , {x}_{j} , {X}_{N - 1} , {X}_{N} ]$$

where N is the number of variables defined for each event in the training data set 252.

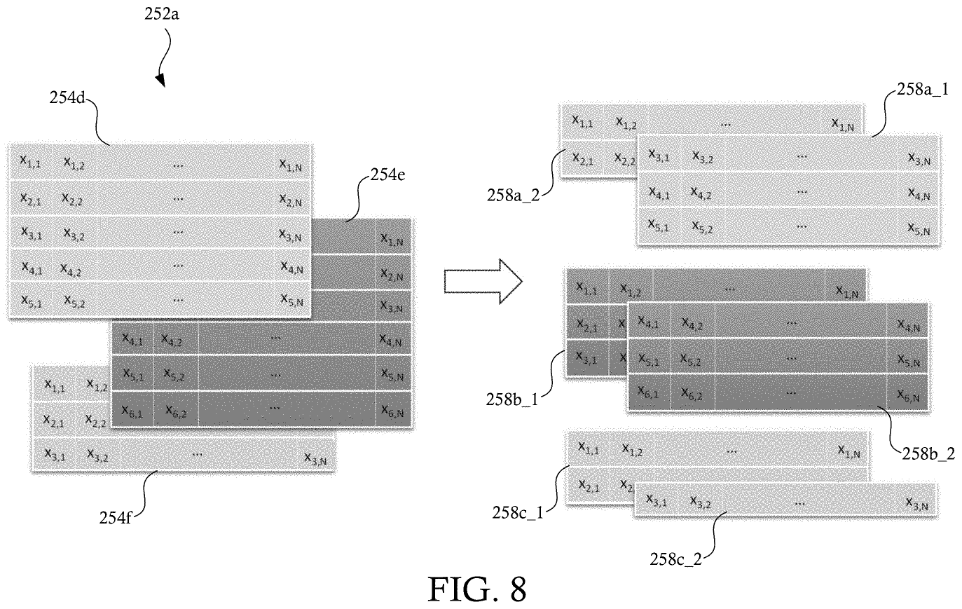

In some embodiments, the training data set 252 include historical interactions 254d-254c divided into one or more subsets 258a_1-258c_2 defined by a window, as illustrated in FIG. 8. For example, in embodiments including events having a temporal parameter, a window may be defined as a predetermined temporal period, such as, for example, a predetermined number of days, weeks, months, etc. Each window may be discrete (e.g., not including overlapping time periods) and/or rolling (e.g., including overlapping time periods and events). For example, in some embodiments, a window of 90 days may be defined in rolling 30-day increments such that each subsequent window contains events overlapping in a 60-day period. Although specific embodiments are discussed herein, it will be appreciated that any suitable time window and/or rolling increment may be selected for dividing the training data into subsets.

In some embodiments, the set of events E can be divided into a subset of event windows having partially overlapping sets of events. For example, for a set of events E where the set is defined as

$$E = [ {e}_{1}^{1} , {e}_{2}^{1} , {e}_{3}^{2} , … , {e}_{T - 7}^{M - 7} , {e}_{T - 6}^{M - 6} , {e}_{T - 5}^{M - 5} , {e}_{T - 4}^{M - 4} , {e}_{T - 3}^{M - 4} , {e}_{T - 2}^{M - 2} , {e}_{T - 1}^{M - 1} , {e}_{T}^{M} ]$$

where each event includes a month index (superscript) and an event ID index (subscript). A temporal window and a temporal rolling period may be selected such that a set of subsets is defined as:

$$\{ \begin{matrix}[ {e}_{1}^{1} , {e}_{2}^{1} , {e}_{3}^{2} ] , [ {e}_{T - 7}^{M - 7} , {e}_{T - 6}^{M - 6} , {e}_{T - 5}^{M - 5} ] , [ {e}_{T - 6}^{M - 6} , {e}_{T - 5}^{M - 5} , {e}_{T - 4}^{M - 4} , {e}_{T - 3}^{M - 4} ] , [ {e}_{T - 4}^{M - 4} , {e}_{T - 3}^{M - 4} , {e}_{T - 2}^{M - 2} ] , \\ [ {e}_{T - 2}^{M - 2} , {e}_{T - 1}^{M - 1} ] , [ {e}_{T - 2}^{M - 2} , {e}_{T - 1}^{M - 1} , {e}_{T}^{M} ]\end{matrix} \}$$

Although specific embodiments are discussed herein, it will be appreciated that any suitable window and rolling period configured to generate any suitable subset of events may be defined. FIG. 8 illustrates a training data set 252a that includes a first set of historical events 254d associated with a first user, a second set of historical events 254e associated with a second user, and a third set of historical events 254f associated with a third user, in accordance with some embodiments. The sets of historical events 254d-254f can be divided based on a window into a plurality of subsets 258a_1-258c_2 of the historical events 254d-254f. A set of the plurality of subsets 258a_1-258c_2 are selected to generate one or more 3D tensor training sets 256a-256c. Each of the 3D tensors 256a-256c includes a set of predetermined number of subsets 258a_1-258c_2.

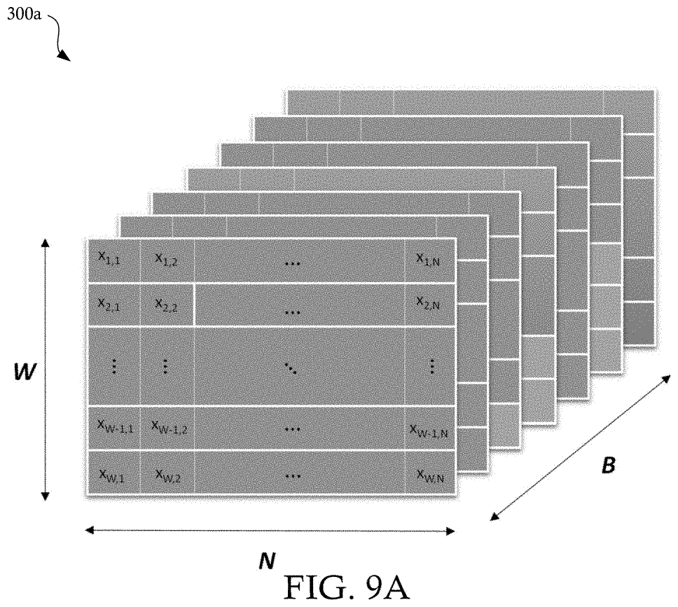

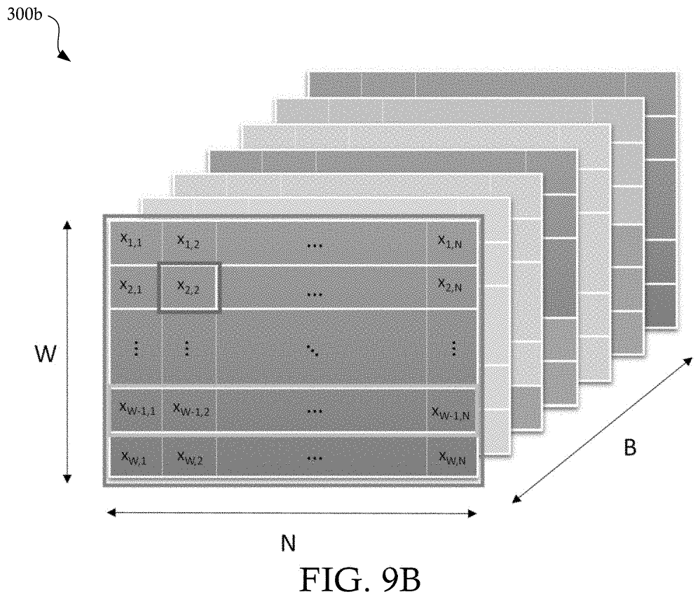

In some embodiments, a training subset 300a-300c is generated by combining subsets 258a_1-258c_2 of historical events associated with multiple customers, as illustrated in FIGS. 9A-9B. FIG. 9A illustrates a training subset 300a generated by selecting subsets of events associated with only a first customer, in accordance with some embodiments. Similarly, FIG. 9B illustrates a training subset 300b generated by randomly selecting subsets of events associated with a first customer, a second customer, and a third customer, in accordance with some embodiments. Although specific embodiments are discussed herein, it will be appreciated that training subsets may be generated by combining any number of historical events 254a-254f and/or any number of subsets 256a-256f of historical events 254a-254f associated with one or more customers according to any suitable selection and/or combination process.

In some embodiments, training data subsets may be generated based on an indexing and shuffling process. For example, each of the plurality of subsets 258a_1-258c_2 may be sorted into two or more index values, such as two or more folders. The events in the training data set 252 (or any subset thereof) may be sorted randomly, sequentially, and/or based on any suitable sorting process. After being indexed, a training subset may be generated by selecting at least one event from each indexed set (e.g., each folder). A subset may be selected from each indexed set sequentially, randomly, and/or according to any suitable selection process (e.g., first-in-first-out, first-in-last-out, last-in-first-out, last-in-last-out, etc.).

In some embodiments, the training data set 252 (and/or any other data set, such as a validation data set 262 or an evaluation data set 290 discussed below) contain only interactions which are not identified by a set of predefined rules or supervised machine learning models which are used to stop transactions following known fraudulent patterns. A validation data set 262 may be divided based on a ratio of benign/legitimate interactions to anomalous/fraudulent interactions. For example, in some embodiments, subsets of training data may be generated that include 100% legitimate interactions, 90% legitimate interactions, 80% legitimate interactions, etc., 100% anomalous interactions, 90% anomalous interactions, 80% anomalous interactions, etc., and/or any other suitable ratio of legitimate to anomalous interactions.

At step 206, the training data set 252 (or subset thereof, e.g., historical events 254a-254c, subsets 256a-256c, or training subsets 300a-300c) is provided to an untrained model 258 to iteratively generate an anomaly detection model 154. During an iterative training process, the untrained model 258 performs steps similar to those discussed above with respect to anomaly detection model 154, i.e., given an input tensor, encoding the input tensor using an encoder block, decoding the encoded vector using a decoder block, and outputting a 2D tensor. The untrained model 258 compares the input tensor to the output tensor and modifies one or more parameters or elements of the untrained model 258 based on the comparison. After modifying the parameters of the model, an interim model 260 is generated. The interim model 260 is used for the next stage of iterative training. Training of the untrained model 258 may occur serially and/or in parallel and may be performed over multiple systems and/or multiple simultaneous iterations. In some embodiments, the training process may continue until the average difference between a pair of input 2D tensor E′ and output 2D tensor E of each of the 2D tensor E in the validation set is less than predetermined value ∈, where:

$$a v g ( diff ( {E}^{′} , E ) ) = avg ( diff ( {E}^{′} , {f}_{θ} ( {E}^{′} ) ) ) < ϵ$$

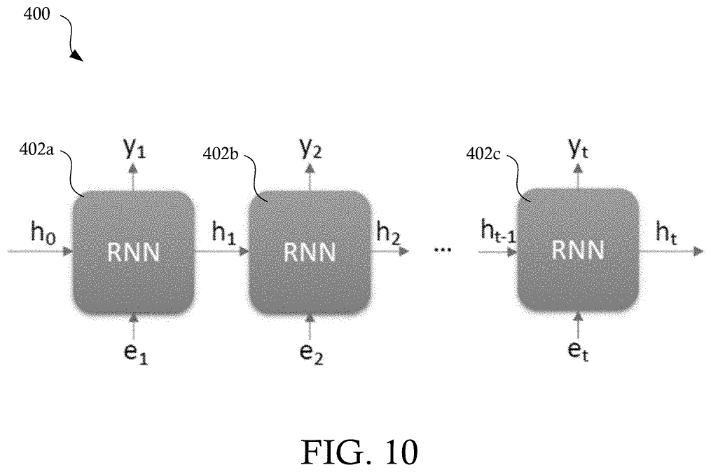

In some embodiments, the untrained model 258 includes one or more RNN networks, for example, a first RNN encoder network and a second RNN encoder network, as illustrated in FIG. 10. Although the RNN networks illustrated in FIG. 10 include only a single layer of RNN nodes, it will be appreciated that the RNN networks may include multiple RNN layers with each layer consisting of one RNN network or node applied W times (e.g., 402a-402c) to a sequence of W data. The RNN network 400 includes a plurality of RNN nodes 402a-402c. RNN nodes (or units) are configured to receive an event input eₜ and a hidden state input hₜ₋₁ at time t. The event input eₜ includes at least one event from the training data set 252 (i.e., an event included in a training subset 300a-300b provided to the network). The hidden states h₀-hₜ₋₁ is generated by an RNN unit 402a-402b in the network 400. The hidden state input h₀ to the first node 402a may be pre-generated and/or randomly generated.

In some embodiments, each RNN unit is configured to generate an output yₜ:

$${y}_{t} = {W}_{y h} {h}_{t} + {b}_{y}$$

where W_{yh} is a weight matrix, b_{y} is a bias vector at the output state of the RNN unit 402a-402c, and hₜ is determined by the equation:

$${h}_{t} = tanh ( {W}_{h h} {h}_{t - 1} + {W}_{h e} {e}_{t} + {b}_{h} )$$

where hₜ₋₁ is the hidden vector output from the prior RNN unit, Wₕₕ is the weight matrix applied to the prior hidden vector, Wₕₑ is a weight matrix applies to the current input event, bₕ is a bias vector, and tanh is an activation function. W_{yh}, Wₕₕ, Wₕₑ, b_{y}, bₕ are each model parameters that may be adjusted during the training process, for example, using backpropagation.

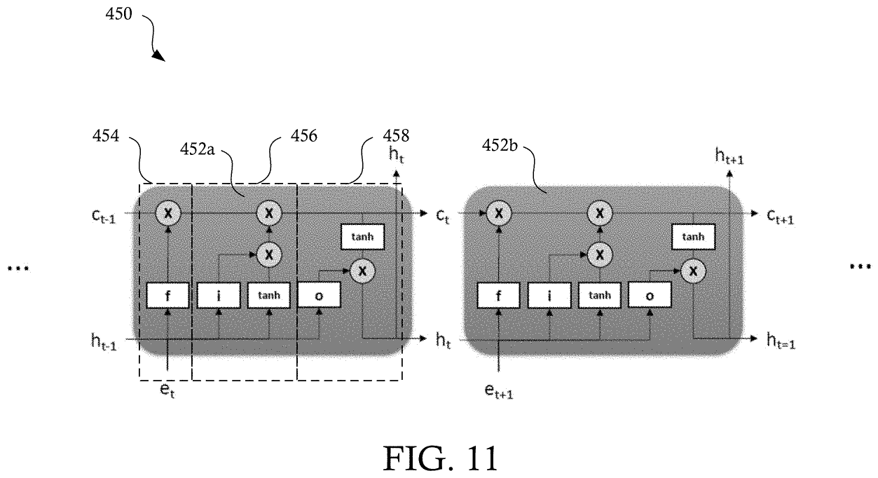

In some embodiments, the RNN network 400 may be implemented with long short-term memory (LSTM) units (or nodes). An LSTM network 450, as illustrated in FIG. 11, provides feedback connections that allow processing of sequences of interconnected data. Although the LSTM network 450 is well-suited for processing time series data, such as historical event data 252, it will be appreciated that any suitable back-propagation or memory mechanism may be implemented.

The LSTM network 450 could include a plurality layers of LSTM units each including one or more LSTM units applied W times to a sequence with W events (452a-452b). Each of the LSTM units 452a-452b includes a forget gate 454, an input gate 456, and an output gate 458. An LSTM unit at time t+1 is configured to receive an event vector eₜ₊₁, a memory cell cₜ, and a hidden state hₜ. An event input eₜ₊₁ includes a list of event variables xⱼ, where j is less than or equal to the number of event variables N for a given event. In some embodiments, the hidden state hₜ₊₁ and memory cell cₜ are vectors containing H variables. A memory cell may be used to keep information from long short-term events (e.g., event received earlier than eₜ₊₁). A hidden state may be used to keep information from recent short-term events (e.g., events received before but close in time to eₜ₊₁).

The input gate i_{t+1 1} 456 is configured to receive an event input eₜ₊₁ from a training subset of historical events. The input gate 456 would be adjusted based on the received input event eₜ₊₁ and the hidden state hₜ. In some embodiments, the input gate 456 determines the manner in which a memory cell candidate \tilde{c}ₜ₊₁ (which may also be calculated based on the received input event eₜ₊₁ and the hidden state hₜ) is used to modify the untrained model 258. In some embodiments, an activation function, such as a sigmoid function σ is applied. In some embodiments, an input gate 456 serves as a filter function and may be configured to consider a prior hidden state hₜ and the event input eₜ₊₁ to determine a weighting of a memory cell candidate \tilde{c}ₜ₊₁ to be included in the memory cell cₜ₊₁.

The forget gate fₜ₊ᵢ₁ 454 is configured to identify details maintained in memory cell cₜ from the prior LSTM unit 452a-452b that should be discarded. For example, in some embodiments, the forget gate 454 applies an activation function σ, such as a sigmoid function. In some embodiments, the forget gate 454 serves as a filter function configured to look at a prior hidden state hₜ and the event input eₜ₊₁ to determine a weighting (e.g., zero for a value to be discarded or 1 for a value to be kept) of the memory cell cₜ from a prior LSTM unit. The weights may be applied to each number in a cell state provided from the prior cell 452a-452b. In some embodiments, current memory cell cₜ₊₁ can be calculated as a sum of a portion of previous memory cₜ (potentially adjusted by forget gate) and a portion of the memory cell candidate \tilde{c}ₜ (potentially adjusted by the input gate).

The output gate oₜ₊₁ 458 is configured to determine hidden vector hₜ₊₁ of the current LSTM unit 452a-452b. For example, in some embodiments, an output gate 458 provides a filter function configured to consider a prior hidden state hₜ and the vent input eₜ₊₁ to determine a weighting (e.g., zero for a value to be discarded or 1 for a value to be kept) of the memory cell cₜ₊₁ to determine which memory cell values are used as the hidden state hₜ₊₁ to modify the untrained model 258. In some embodiments, an activation function, such as a tanh function, is applied to determine a weighting of the memory cell cₜ₊₁ included in the output. In some embodiments,

$${\tilde{c}}_{t + 1} = tanh ( {W}_{ce} {e}_{t + 1} + {W}_{ch} {h}_{t} + {b}_{c} )$$

$${i}_{t + 1} = σ ( {W}_{i e} {e}_{t + 1} + {W}_{i h} {h}_{t} + {b}_{i} )$$

$${f}_{t + 1} = σ ( {W}_{f e} {e}_{t + 1} + {W}_{f h} {h}_{t} + {b}_{f} )$$

$${o}_{t + 1} = σ ( {W}_{o e} {e}_{t + 1} + {W}_{o h} {h}_{t} + {b}_{o} )$$

$${c}_{t + 1} = {f}_{t + 1} \times {c}_{t} + {i}_{t + 1} \times {\tilde{c}}_{t + 1}$$

$${h}_{t + 1} = {o}_{t + 1} \times tanh ( {c}_{t + 1} )$$

where W_{ce}, W_{ch}, b_{c}, Wᵢₑ, Wᵢₕ, bᵢ, W_{fe}, W_{fh}, b_{f}, Wₒₑ, Wₒₕ, and bₒ are parameters of a LSTM unit that may be adjusted during training, such as via backpropagation to the LSTM network 450.

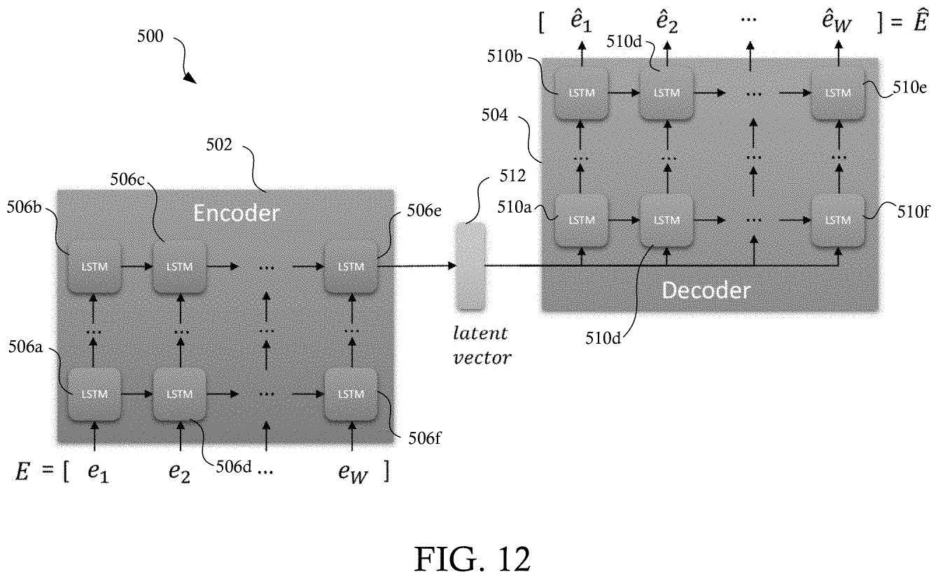

FIG. 12 illustrates an embodiment of a self-supervised model 500 with encoder-decoder architecture including a plurality of LSTM layers, in accordance with some embodiments. The self-supervised model 500 includes an encoder block 502 and a decoder block 504. The encoder block 502 is configured to receive an input tensor E (for example, a 2D tensor). In some embodiments, each of input tensor E includes a plurality (e.g., a sequence) of event vectors e₁-e_{w}, where W represents the sequence length. Each event vector e₁-e_{T} may be sequentially provided to a LSTM unit 506a-506f at time t. The plurality of LSTM layers generate a vector encoding 512 of the tensor E. The vector encoding 512 is provided to the decoder block 504.

The decoder block 504 is configured to receive the vector encoding 512 and generate an output tensor Ê, which is a reconstruction of the initial input tensor E. The objective of the encoder block 502 and the decoder block 504 is to generate an output tensor Ê that is substantially equal to the input tensor E. The vector encoding 512 is provided to one or more layers of LSTM cells 510a-510f in the decoder block 504 configured to perform a reverse operation as compared to the LSTM cells 506a-506f of the encoder block 502.

In some embodiments, one or more categorical variables of an event vector eₜ included in an initial tensor E are converted to a vector prior to being provided to an encoder block 502. One or more vector conversion processes may be applied to convert information included in an initial vector eₜ to a dense representation. For example, in some embodiments, store information and/or item information may be converted into vectors prior to being provided to the encoding block 502. One or more embedding layers may be used to convert the identified information into a vector representation.

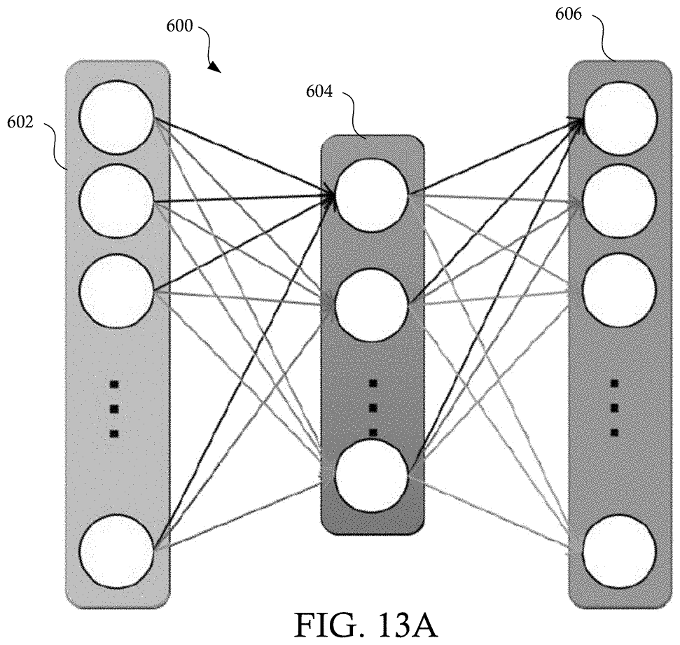

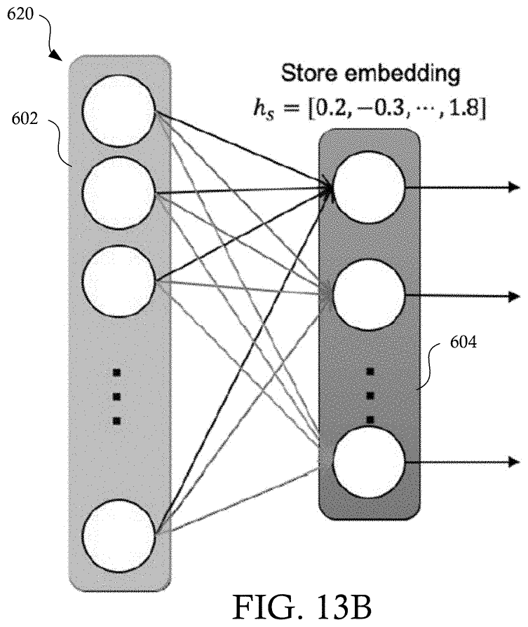

For example, in some embodiments, a store vector conversion process including at least one embedding layer is configured to convert store information into a vector representation. FIG. 13A illustrates one embodiment of a store prediction model 600 during training, in accordance with some embodiments. The store prediction model 600 is trained (i.e., configured) to receive a first store identifier at an input layer 602 and predict the next store that will be visited by a customer. The input layer 602 and the hidden layer 604 are configured to convert the store identifier (such as, for example, a store listing or store number) into a store embedding (i.e., a vector representation of the store). In some embodiments, the output layer 606 is trained to output a store identifier of the next store visited by a customer after visiting the initial store. The training process causes two stores (e.g., A and B) to have similar store embeddings if a customer visits the same store (e.g., C) after visiting either store A or B. In some embodiments, and as shown in FIG. 13B, after training the store prediction model 600, the store prediction model 600 is truncated at the hidden layer 604 (i.e., the output layer 606 is removed) to generate a store vector conversion model 620. In some embodiments, the store embedding is provided as an input to the encoding block 502 of the self-supervised model 500.

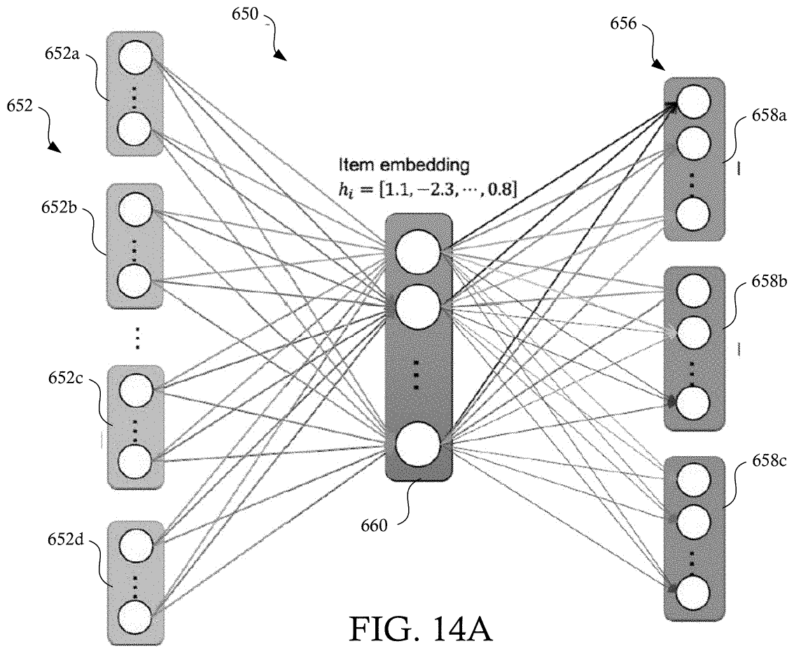

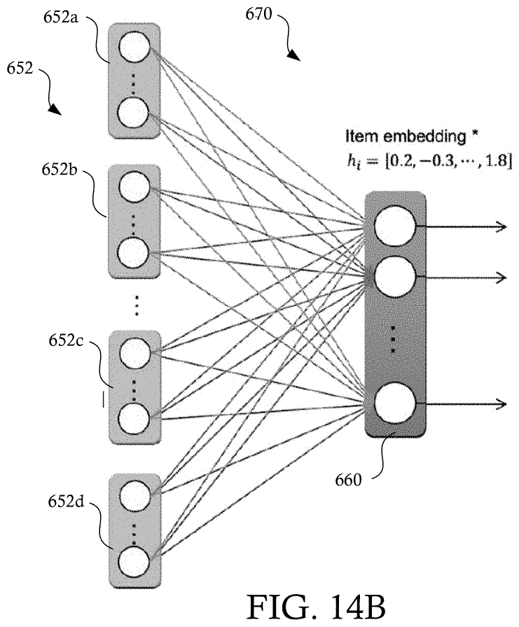

As another example, in some embodiments, an item vector conversion process is configured to convert an item description into a vector representation. FIG. 14A illustrates one embodiment of an item classification model 650, in accordance with some embodiments. During training, the item classification model 650 is trained (i.e., configured) to map an item description received at an input layer 652 to a plurality of categories 658a-658c in an output layer 656. In some embodiments, one or more conversion models (e.g., word2vec models) are configured to convert the alphanumeric elements 652a-652d of an item description 652 to an item embedding configured to predict corresponding categories 658a-658c of the item. A hidden layer 660 is configured to generate an item embedding (i.e., a vector representation of the item description). The item embedding identifies the categories 658a-658c corresponding to the item description. In some embodiments, and as shown in FIG. 14B, after training, the item classification model 650 is truncated at the hidden layer to generate an item vector conversion model 670. In some embodiments, the item embedding generated by the item vector conversion model 670 is provided as an input to the encoding block 502 of the self-supervised model 500.

At step 208, a trained anomaly detection model 154a is generated. The trained anomaly detection model 154a is configured to perform the steps discussed above with respect to anomaly detection model 154. The trained anomaly detection model 154a may be deployed to one or more systems configured to perform anomaly detection, such as, for example, the anomaly detection system 26, the interaction systems 22a-22b, and/or any other suitable system.

At optional step 210, the trained anomaly detection model 154a is verified using a validation data set 262 and/or an evaluation data set 290. The validation data set 262 may include a subset of the training data set 252 and/or be a separate data set. Similar to the training data set 252. The validation data set 262 may include a set of known benign interactions (e.g., transaction that have not been identified by predefined rules or other supervised machine learning models as conforming to known fraudulent patterns) and/or a set of known fraudulent transactions. The validation data set 262 may be provided to the trained anomaly detection model 154a to verify identification of benign and/or fraudulent transactions at an acceptable rate. In some embodiments, an evaluation data set 290 may be used to evaluate a trained anomaly detection model 154a. The evaluation data set 290 may include both benign/legitimate transactions and anomalous/fraudulent transactions. In some embodiments, the evaluation data set 290 is divided based on a ratio of benign/legitimate interactions to anomalous/fraudulent interactions.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory having instructions stored thereon and a processor configured to read the instructions to:
receive interaction data representative of one or more interactions;
classify the one or more interactions as one of an anomalous interaction or a benign interaction using an anomaly detection model, wherein the anomaly detection model is configured to identify a similarity between the interaction data and known benign interactions;
generate an indication of authorization based on the classification of the interaction, wherein the indication of authorization authorizes the interaction when the anomaly detection model classifies the interaction as benign, and wherein the indication of authorization denies the interaction when the anomaly detection model classifies the interaction as anomalous.

2. The system of claim 1, wherein the interaction data includes at least one alphanumeric variable of the interaction, and wherein the anomaly detection model is configured to convert the at least one alphanumeric variable into a vector embedding.

3. The system of claim 2, wherein the at least one alphanumeric variable includes a store identifier, and wherein the anomaly detection model is configured to convert the store identifier into a store embedding using a store vector conversion model.

4. The system of claim 3, wherein the store vector conversion model includes at least one hidden layer configured to generate a vector representation of the store identifier.

5. The system of claim 2, wherein the at least one alphanumeric variable includes item variables, and wherein the anomaly detection model is configured to convert the item variables into an item embedding using an item vector conversion model.

6. The system of claim 5, wherein the item vector conversion model includes at least one word2vec layer configured to generate a vector representation of the item variables.

7. The system of claim 1, wherein the anomaly detection model comprises a plurality of long short term memory (LSTM) cells.

8. The system of claim 1, wherein the anomaly detection model comprises an encoder and decoder framework configured to generate an output tensor.

9. The system of claim 8, wherein anomaly detection model is configured to classify the one or more interactions based on a similarity between an input tensor generated from the interaction data and the output tensor.

10. The system of claim 9, wherein the similarity between the input tensor and the output tensor is generated according to the equation:
$$diff ( {E}^{′} , E ) \frac{1}{W} {\sum }_{t = 1}^{W} ( {e}_{t}^{′} , {e}_{t} )$$
where e′ₜ is vectorized input data of the input tensor having an index t, êₜ is a corresponding output vector in the output tensor, W is a total number of vectors in each of the input tensor and output tensor, and L is a loss function.

11. A non-transitory computer readable medium having instructions stored thereon, wherein the instructions, when executed by a processor cause a device to perform operations comprising:
receiving interaction data representative of one or more interactions;
classifying the one or more interactions as one of an anomalous interaction or a benign interaction using an anomaly detection model, wherein the anomaly detection model is configured to identify a similarity between the interaction data and known benign interactions using an encoder-decoder framework;
generating an indication of authorization based on the classification of the interaction, wherein the indication of authorization authorizes the interaction when the anomaly detection model classifies the interaction as benign, and wherein the indication of authorization denies the interaction when the anomaly detection model classifies the interaction as anomalous.

12. The non-transitory computer readable medium of claim 11, wherein the interaction data includes at least one alphanumeric variable of the interaction, and wherein the anomaly detection model is configured to convert the at least one alphanumeric variable into a vector embedding.

13. The non-transitory computer readable medium of claim 12, wherein the at least one alphanumeric variable includes a store identifier, and wherein the anomaly detection model is configured to convert the store identifier into a store embedding using a store vector conversion model.

14. The non-transitory computer readable medium of claim 13, wherein the store vector conversion model includes at least one hidden layer configured to generate a vector representation of the store identifier.

15. The non-transitory computer readable medium of claim 12, wherein the at least one alphanumeric variable includes item variables, and wherein the anomaly detection model is configured to convert the item variables into an item embedding using an item vector conversion model.

16. The non-transitory computer readable medium of claim 15, wherein the item vector conversion model includes at least one word2vec layer configured to generate a vector representation of the item variables.

17. The non-transitory computer readable medium of claim 1, wherein the anomaly detection model comprises a plurality of long short term memory (LSTM) cells.

18. The non-transitory computer readable medium of claim 11, wherein anomaly detection model is configured to classify the interaction based on a similarity between an input tensor generated from the interaction data and an output tensor, and wherein the output tensor is generated by the encoder-decoder framework.

19. The non-transitory computer readable medium of claim 18, wherein the similarity between the input vector and the output tensor is generated according to the equation:
$$diff ( {E}^{′} , E ) \frac{1}{W} {\sum }_{t = 1}^{W} ( {e}_{t}^{′} , {e}_{t} )$$
where e′ₜ is vectorized input data of the input tensor having an index t, êₜ is a corresponding output vector in the output tensor, W is a total number of vectors in each of the input tensor and output tensor, and L is a loss function.

20. A method, comprising:
receiving interaction data representative of an interaction;
classifying the interaction as one of an anomalous interaction or a benign interaction using an anomaly detection model, wherein the anomaly detection model is configured to identify a similarity between the interaction data and known benign interactions using a loss function to determine a similarity between the data representative of the interaction and an output of the anomaly detection model;
generating an indication of authorization based on the classification of the interaction, wherein the indication of authorization authorizes the interaction when the anomaly detection model classifies the interaction as benign, and wherein the indication of authorization denies the interaction when the anomaly detection model classifies the interaction as anomalous.
